(19) United States
(12) Patent Application Publication
(10) Pub. No.: US 2016/0215727 A1
(43) Pub. Date: Jul. 28, 2016

(54) AFTERBODY FOR A MIXED-FLOW TURBOJET ENGINE COMPRISING A LOBED MIXER AND CHEVRONS WITH A NON-AXISYMMETRIC INNER SURFACE

(71) Applicant: SNECMA, Paris (FR)

(72) Inventors: Jonathan LANGRIDGE, Moissy-Cramayel cedex (FR); Guillaume BODARD, Moissy-Cramayel cedex (FR); Irwin KERNEMP, Moissy-Cramayel cedex (FR); Maxime KOENIG, Moissy-Cramayel cedex (FR); Julien SZYDLOWSKI, Moissy-Cramayel cedex (FR)

(21) Appl. No.: 14/914,235

(22) PCT Filed: Sep. 9, 2014
(86) PCT No.: PCT/FR2014/052221

§ 371 Date: Feb. 24, 2016

(30) Foreign Application Priority Data
Sep. 10, 2013 (FR) 1302114

(51) Int. Cl. F02K 1/34; F02K 1/38

(52) U.S. Cl. CPC F02K 1/34; F02K 1/386

(57) ABSTRACT

The invention concerns an afterbody for a mixed-flow turbojet engine having a central axis (LL), comprising a lobed mixer (6), having alternating hot lobes (12) projecting into the secondary flow (F2) and cold lobes (13) penetrating into the primary flow (F1), and a nozzle (1) comprising, on the trailing edge (14) of same, longitudinal indentations (15) defining a crown of noise-reducing chevrons (7), characterised in that, at a predefined abscissa (X5) on the central axis (LL) downstream from the lobed mixer (6), the inner wall (2) of the nozzle (1) has a neck where the surface area of the transverse passage section of a flow into the nozzle passes through a minimum, and in that, downstream from this predefined abscissa (X5), the radius of the inner wall (2) of the nozzle (1) varies between the indentations (15) and the chevrons (7) so as to produce, in the flow, in the vicinity of said crown of chevrons (7), azimuth fluctuations of the Mach number. It also concerns a method for designing such an afterbody that comprises setting the azimuth of the lobed mixer (6) and of the chevrons (7).

The present invention relates to the field of noise reduction for a mixed-flow turbojet engine. It relates more particularly to the afterbody of the turbojet engine, in which the primary flow leaving the engine and the secondary flow mix within a nozzle in order to form a jet propelled into the outside air.

The aeroplane turbojet engine has to operate at different speeds according to the flight conditions (cruising, take-off, landing, etc.). The primary function of the afterbody is to control the expansion of the gases in the outside air in order to optimise operational performance criteria that are adapted to these different flight conditions, such as the thrust coefficient at cruising speed or the flow coefficient during take-off.

Moreover, the speed difference between the jet leaving the nozzle and the outside air causes fluid shearing and therefore turbulence, and this causes noise, which is commonly referred to as “jet noise”. This “jet noise” is a broadband noise which is particularly inconvenient during the take-off and landing phases of the aeroplane.

The use of chevrons placed in a ring at the downstream end of the nozzle makes it possible to considerably reduce the low-frequency component of this noise while decreasing the intensity of the largest vortex structures in the mixing zone. The action of the chevrons is, however, generally accompanied by a process of generating small structures which lead to undesirable noise at high frequencies. All the difficulty in designing effective chevrons in acoustic terms consists in producing a good compromise between these two effects without the operational performance deteriorating.

EP1873389 describes chevrons by referring to the benefit of making them return into the jet in order to attenuate the noise and by highlighting the shape of the design of the outline of the trailing edge. In particular, FR2986832 sets out, in the case of a nozzle shape corresponding to an afterbody of a mixed-flow turbojet engine, a configuration of chevrons within which the duct forms a divergent-convergent portion.

Moreover, a lobed mixer may be installed at the confluence of the primary and secondary flows at the inlet of the nozzle, as is indicated for example in FR 2902469 or EP 1870588. By homogenising the mixing of the flows passing into the nozzle, such a device improves the performance of the turbojet engine. It is also noted that such a device has a positive effect on the noise radiated on the sides by the engine at low frequencies. However, the interaction between the turbulence originating from the mixer and the zones of supersonic flow in the nozzle is a source of high-frequency noise. This phenomenon may occur in particular when the nozzle begins to start up.

The way in which this problem is overcome may lead in particular either to the geometry of the nozzle being modified in order to delay the appearance of pockets of greater than Mach 1 depending on the expansion ratio or to the efficiency of the mixer being reduced. This generally has the disadvantage of reducing the operating margins, and this is linked to a reduction in the flow rate at low expansion ratios and/or a loss of the thrust coefficient.

The present invention aims to advantageously combine, in a mixed-flow turbojet engine, the use of a lobed mixer and modifications to the outlet end of the nozzle, in particular including chevrons, in order to improve the acoustic performance while maintaining the operating margins and the operational performance of the turbojet engine.

### DESCRIPTION OF THE INVENTION

In order to solve these problems, the invention relates to an afterbody of a mixed-flow turbojet engine, having a central axis, comprising a lobed mixer that has hot lobes returning to the secondary flow alternating with cold lobes penetrating the primary flow, and an nozzle comprising, on its trailing edge, longitudinal notches defining a ring of anti-noise chevrons. Said afterbody is distinguished in that, on one defined abscissa on the central axis downstream of the lobed mixer, the inner wall of the nozzle has a neck where the area of the passage cross section of a flow in the nozzle passes through a minimum, and in that, downstream of this defined abscissa, the radius of the inner wall of the nozzle varies between the notches and the chevrons so as to produce azimuth fluctuations in the Mach number in the flow in the vicinity of said ring of chevrons.

This configuration makes it possible to ensure that the vortex structures produced by the lobed mixer pass, close to the outlet of the nozzle, through regions in which the flow is supersonic which are less extensive than in the case of a “smooth” nozzle. In this case, “smooth” nozzle is intended to mean a nozzle of which the portion of the inner wall in a plane transverse to the axis of the jet engine rests on a circle as far as its trailing edge. Since the interaction of the vortex structures with the supersonic flow produces sources of noise, in particular at high frequency, the intensity of these sources is minimised by combining, for different operating modes, the positive effects on noise attenuation between the lobed mixer and the chevrons. This therefore avoids having to resort to solutions which reduce the operational performance in order to solve the problem of reducing noise.

Advantageously, the lobed mixer produces, in the flow in the vicinity of the ring of chevrons, spatial fluctuations in azimuth with the vortex intensity level and the ring of chevrons is positioned in azimuth relative to the lobed mixer such that, in its vicinity, the azimuth of at least one maximum vortex intensity level corresponds to a minimum Mach number in the azimuth fluctuations of the flow in the nozzle in the vicinity of the ring of chevrons.

The vortex intensity of a velocity field will be defined in this case as the vorticity module of this vector field. Since the flows in question are generally turbulent, it relates to the vortex intensity of the average speed over time. This field of average speeds for an operating mode of the turbojet engine may be estimated by a calculation method or by measurements. The mixer produces vortices in the flow, the centre of each of these vortices being a maximum local vortex intensity. The arrangement between the mixer and the ring of chevrons according to the invention makes the zones of the flow having a lower Mach number consistent with the passage of the main vortex structures produced by the lobed mixer and thus optimises the effects of combining the two means.

Preferably, the mixer and the nozzle together with the ring of chevrons are each rotationally symmetrical about the axis of the turbojet engine.

According to different variants of these embodiments of the invention, which may be taken together or separately:
the number of hot lobes of the mixer and the number of chevrons are identical;
the points of the chevrons are in the same axial planes as the maximum-radius points of a hot lobe;
the variations in radius of the inner wall of the nozzle in the end part define, in azimuth, sectors in which the radius has a maximum value in the region of the notches and sectors in which the radius has a minimum value in the region of the chevrons;
the surface of the inner wall of the nozzle continuously comes closer to the axis of the turbojet engine in the sectors in which the radius has a minimum value.

According to a particular embodiment, the inner wall of the nozzle has a circular cross section as far as a defined abscissa, said inner wall having a defined upstream tangent at this abscissa in the entire axial half-plane, and:
in the axial half-plane passing through the apex of a notch, the inner wall of the nozzle deviates radially, towards the outside; from said upstream tangent passing through the point of the inner wall corresponding to said abscissa in this half-plane;
in the axial half-plane passing through the point of a chevron, the inner wall of the nozzle deviates radially, towards the inside, from said upstream tangent passing through the point of the inner wall corresponding to said abscissa in this half-plane.

The invention also relates to a turbojet engine equipped with such an afterbody. It relates in particular to a turbojet engine in which the relative azimuth positioning between the lobed mixer and the ring of chevrons is determined such that the azimuth fluctuations in the Mach number produce, in the vicinity of the neck of the nozzle in an annular region in which the supersonic flow begins to appear, pockets in which the flow remains subsonic, when the nozzle beings to start up, preferably when the expansion ratio at start-up is less than 1:7 and more preferably when it is between 1:5 and 1:6. In the context of the invention, the expansion ratio is defined by the ratio between an average pressure downstream of the lobed mixer, in the region of the neck of the nozzle, and the ambient static pressure.

The invention also relates to a method for designing a mixed-flow turbojet engine comprising an afterbody as defined above, which is designed to comprise a nozzle equipped with a ring of chevrons having variations in the radii of the inner wall between the notches and the chevrons so as to produce azimuth fluctuations in the Mach number in the flow in the vicinity of said ring of chevrons, and comprises a lobed mixer. The method is distinctive in that it comprises:
at least one step of using a method for analysing the radiated noise for at least one relative positioning value in azimuth of the mixer and of the ring of chevrons, of which the shapes have been previously defined, for at least one operating mode of the turbojet engine;
the use of an algorithm using the preceding step to determine the relative positioning in azimuth between the lobed mixer and the ring of chevrons which minimises the radiated noise analysed for said operating mode.

Advantageously, the number of lobes of the mixer and the number of chevrons used in this method are identical.

In such a method, the afterbody may be designed such that the nozzle begins to start up in an operating mode of the turbojet engine that corresponds to the flight conditions of take-off of an aeroplane that is intended to receive the turbojet engine, and wherein the relative positioning in azimuth between the lobed mixer and the ring of chevrons is determined such that the azimuth fluctuations in the Mach number produce, in the vicinity of the neck of the nozzle in an annular region in which the supersonic flow begins to appear, pockets in which the flow remains subsonic.

This makes it possible, in particular, to limit the noise during the take-off phase, which is one of the greatest constraints on this aspect of the performance of the turbojet engine.

Advantageously, in this method, the pockets in which the flow remains subsonic are regularly distributed in azimuth.

In such a method, the afterbody is designed such that the nozzle preferably begins to start up at an expansion ratio at start-up of less than 1:7 and more preferably at an expansion ratio of between 1:5 and 1:6.

### DETAILED DESCRIPTION OF THE INVENTION

The present invention will be more readily understood and other details, features and advantages of the present invention will become clearer upon reading the following description with reference to the accompanying drawings, in which:

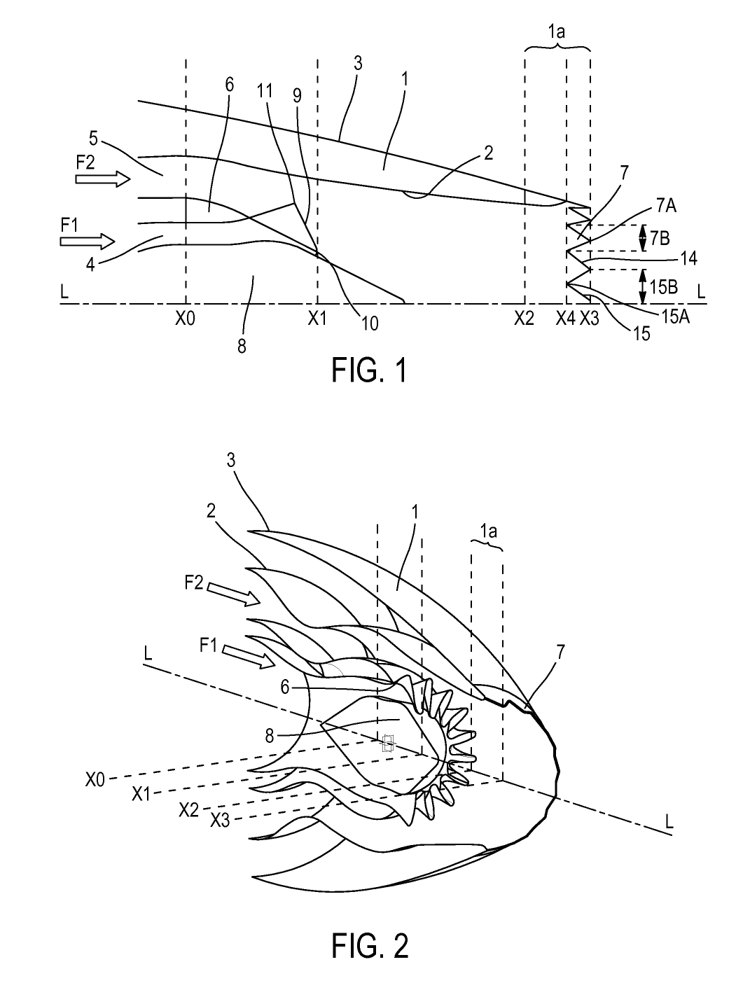

FIG. 1 is a schematic view of an afterbody of a turbojet engine according to the invention, perpendicularly to a section along a half-plane passing through the axis of the turbojet engine.

FIG. 2 is a schematic rear perspective view of the same afterbody which is in section along an axial plane.

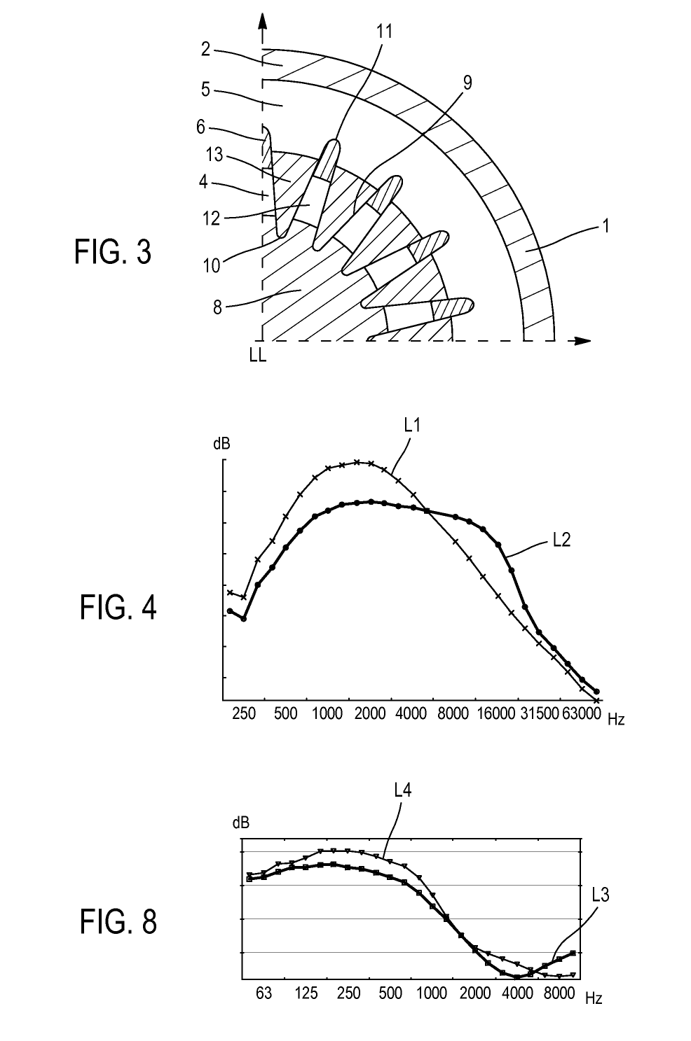

FIG. 3 is a schematic rear view of a quarter of the lobed mixer positioned in the nozzle of the afterbody.

FIG. 4 shows measurement results which show the comparison of the frequency distribution of the noise generated by the afterbody of a mixed-flow jet engine in the presence and in the absence of a lobed mixer according to the invention in the nozzle.

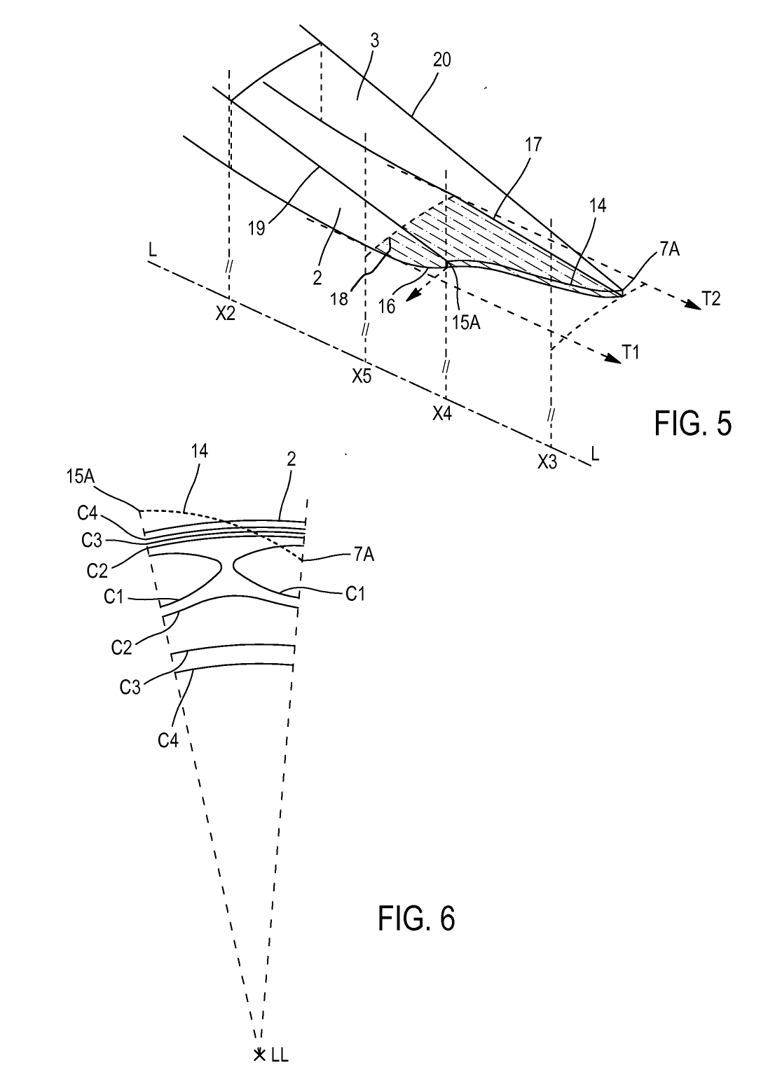

FIG. 5 is a schematic perspective view of the end part of the nozzle on a chevron corresponding to an embodiment of the invention.

FIG. 6 schematically shows the Mach number distribution in the section of the neck during start-up in an afterbody of a turbojet engine according to the invention.

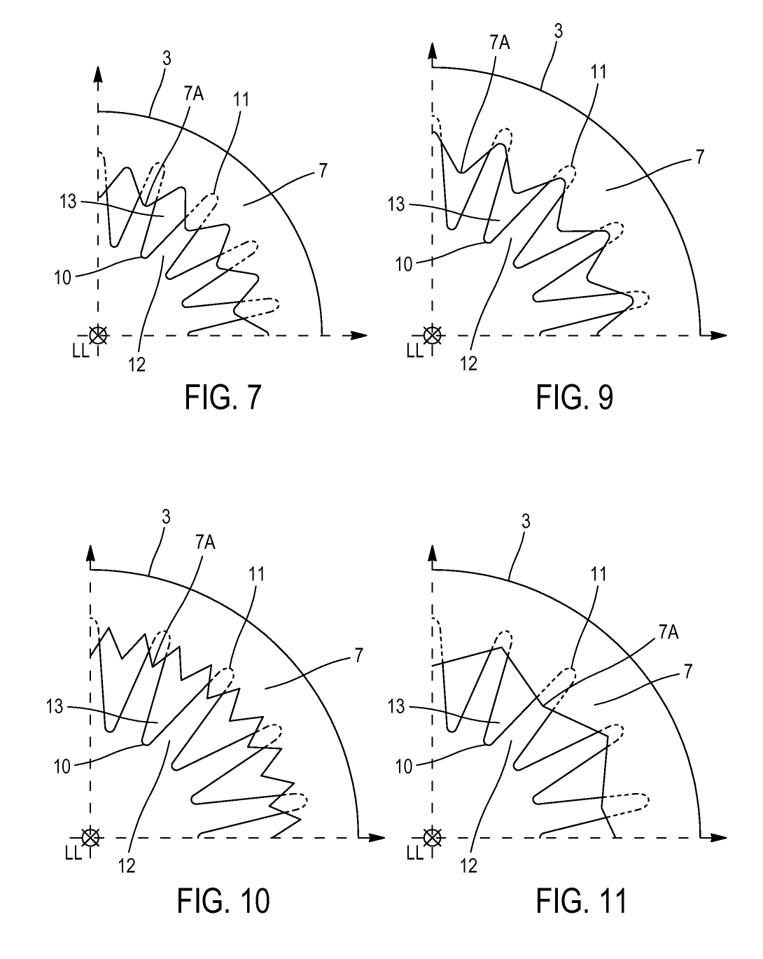

FIG. 7 is a schematic rear view of an afterbody according to a first embodiment of the invention combining the lobed mixer and the ring of chevrons.

FIG. 8 shows the acoustic gains by frequency in a direction perpendicular to the axis of the turbojet engine, which are obtained by the presence of chevrons with the first embodiment combining the lobed mixer and rings of chevrons and with an afterbody that does not comprise a mixer.

FIG. 9 is a schematic rear view of an afterbody according to a second embodiment of the invention combining the lobed mixer and the ring of chevrons.

FIG. 10 is a schematic rear view of an afterbody according to a third embodiment of the invention combining the lobed mixer and the ring of chevrons.

FIG. 11 is a schematic rear view of an afterbody according to a fourth embodiment of the invention combining the lobed mixer and the ring of chevrons.

With reference to FIGS. 1 and 2, the invention relates to an afterbody of a turbojet engine, having a central axis LL, comprising:
a nozzle 1 of which the inner wall 2, which has a substantially circular cross section relative to the central axis LL of the turbojet engine, defines the peripheral surface of the duct in which an internal flow of gas flows and of which the outer wall 3 is in contact with the outside air;
an inlet 4 for a primary flow F1 in the nozzle, having a substantially axisymmetric section in a transverse inlet plane in the nozzle 1 and being on abscissa X0 on the axis LL;
an inlet 5 for a secondary flow F2 in the nozzle surrounding the inlet 4 for the primary flow in the same transverse inlet plane in the nozzle 1, also having a substantially axisymmetric section in this plane;
a lobed mixer 6 arranged in the nozzle 1 at the confluence between the inlet 4 for the primary flow and the inlet 5 for the secondary flow;
an end part 1a of the nozzle 1 designed to form, at the confluence of the output jet of the nozzle with the flow of outside air, anti-noise chevrons 7 combined with deformation in the inner wall 2 of the nozzle in the circumferential direction.

Moreover, as is shown in FIGS. 1 to 3, the afterbody may comprise a central body 8 that limits the radial extension of the duct within the nozzle 1. This central body 8 is not part of the invention. If it is present, its shape is taken into account in the geometry of the nozzle 1 and of the lobed mixer in order to adapt the geometry of the duct through which the mixture of the primary and secondary flows passes, within the nozzle, to the operation of the turbojet engine. The shape of the inner wall of the nozzle is designed by a person skilled in the art by taking into account in particular the thrust coefficient obtained at a high expansion ratio of the flow passing within the nozzle at cruising speed and the flow coefficient obtained at a low expansion ratio, corresponding for example to take-off.

With reference to FIG. 1, the lobed mixer 6 is a profiled part extending within the nozzle 1 as far as a defined abscissa X1, the walls separating the inlet 4 for the primary flow and the inlet 5 for the secondary flow. At its downstream end, it has a trailing edge 9 of which the thickness is generally low in order to prevent a base flow effect between the two flows. The lobed mixer 6 generally ends at a significant distance from the downstream end of the nozzle 1 in order to allow the flow mixture to homogenise.

With reference to FIGS. 1 and 3, an embodiment of the mixer 6 is formed by symmetrical lobes that are periodic in azimuth around the axis LL of the turbojet engine. In this example, the trailing-edge line 9 has a three-dimensional shape that is undulating in azimuth and regular and which passes periodically through a low point 10 of minimum radius and a high point 11 of maximum radius. The shape of the mixer is preferably obtained by joining this trailing-edge line 9 by smooth, regular surfaces to the circular section of the outer wall of the inlet 4 for the primary flow on one side and to the circular section of the inner wall of the inlet 5 for the secondary flow on the other side. Known means allow a person skilled in the art to obtain these smooth surfaces by defining regular radius-variation laws for joining the inlet sections to the trailing edge 9 of the lobed mixer 6.

In the example shown, the changes in the trailing edge 9 of the mixer 6 are periodic. In this way, the average surface between the radially outer wall and the radially inner wall of the mixer 6 undulates periodically in azimuth around the axis LL, and this produces, on the primary-flow side, divergent lobes 12 referred to as hot lobes, under the high points 11 of the trailing edge 9, and, on the secondary-flow side, convergent lobes 13 referred to as cold lobes, above the low points 10 of the trailing edge 9.

In the example shown, the abscissa X1 on the axis LL which determines the maximum extension of the lobed mixer 6 downstream corresponds to the low points 10 of the cold lobes. Likewise, this embodiment of the mixer, which is used in the following to illustrate the benefit of the invention, comprises eighteen symmetrical hot lobes 12 around the axial plane passing through the centre thereof and distributed periodically.

In another embodiment of the invention, it is conceivable to define a lobed mixer 6 by modifying its axial extension X1, the level of penetration of the lobes (determined essentially by the radii of the high points 11 and low points 10 of the trailing edge), the shape of this trailing edge 9 and the number of lobes 12, 13. The lobes may equally not have axial planes of symmetry. Likewise, although the distribution of the lobes 12, 13 is essentially periodic, this periodicity may be locally assigned by modifying the shape of certain lobes, for example in order to adapt the mixer 6 to a strut passage.

The lobed mixer 6 promotes the mixing of the primary flow F1 and secondary flow F2 in the duct within the nozzle 1, in particular by causing shearing and vortices at the interface between the flows. This in particular has an advantageous effect on the noise generated by the turbojet engine by disrupting the large vortex structures in the outlet flow. FIG. 4 shows the acoustic spectrum of the distant noise, which is expressed in decibels relative to the logarithm of the frequency and is generated by the output jet on the side of the jet engine, in a direction on the side at 120 degrees relative to the axis LL of the turbojet engine. These results are obtained for an operating mode of the turbojet engine corresponding to take-off, when noise constraints are the most disadvantageous. The curve L1 corresponds to an afterbody without a lobed mixer, in which the end part of the nozzle 1 is smooth. The curve L2 corresponds to an afterbody equipped with the same nozzle having a smooth end part in which the lobed mixer 6 set out above is installed. It is noted that the presence of the lobed mixer 6 leads to significant acoustic gains at low frequencies, at least up to 2000 Hz.

However, in this same figure, FIG. 4, it is observed that the presence of the lobed mixer 6 causes acoustic degradation at high frequencies, between 8000 and 16,000 Hz. This degradation is explained by the fact that vortex structures generated by the lobed mixer propagate towards the periphery of the outlet section of the nozzle. During the operating mode in question, the flow within the nozzle forms zones in which the Mach number is near to a one in this peripheral region of the duct, close to the outlet of the nozzle. It is the interaction between these vortex structures and the supersonic flow zone that produces the additional high-frequency noise sources that are noted on the curve L2.

It is also noted that the vortex-intensity maximums are produced by the mixer 6 along the interfaces between the hot lobes 12 and cold lobes 13, following the parts of the trailing edge 9 of the mixer 6 that are most closely aligned with a radial direction. These vortex structures are transported by the average flow within the nozzle. A distribution in azimuth of vortex-intensity maximums and minimums having the same periodicity as the mixer lobes 6 is therefore found in the portions close to the outlet end of the nozzle.

The invention also relates to the end part 1a of the nozzle 1. Generally, the inner wall 2 and the outer wall 3 of the nozzle 1 are axisymmetric, that is to say have a circular section in the transverse planes in the region of the lobed mixer 6. With reference to FIG. 1, the end part 1a of the nozzle 1 extends from one transverse plane at the abscissa X2 on the axis LL to the outlet end, in the transverse plane at the abscissa X3. Preferably, the abscissa X2 is located significantly downstream of the abscissa X1 of the end of the lobed mixer 6. In this end part, the inner 2 and outer 3 walls of the nozzle 1 join to form the trailing edge 14 of the nozzle 1, which determines the confluence between the internal flow, leaving the nozzle 1, and the outside air flow.

According to the invention, with reference to FIGS. 1 and 5, the nozzle 1 comprises notches 15 cut into the end part 1a that are in the shape of a rounded triangle on the trailing edge 14. The notches 15 thus define anti-noise chevrons 7 which are also in the shape of a rounded triangle, on the trailing edge 14 in the extension of the nozzle 1. Of course, the notches 15 and the chevrons 7 could have any other appropriate shape (for example trapezoidal).

The notches 15, which are evenly spaced apart in the circumferential direction (although this could be different), are defined by an apex 15A and a base 15B. In the same way, the chevrons 7, which are defined by a point 7A and a base 7B, are evenly spaced apart.

Furthermore, although this could be different, in the example in FIG. 1, the notches 15 are identical to one another. Therefore the same applies to the chevrons 7.

The apex 15A of the notches 15 have an abscissa X4 on the axis LL and the points of the chevrons have the abscissa X3 of the transverse plane defining the end of the nozzle. According to the invention, the end part 1a of the nozzle also has circumferential variations in the radius of the inner wall 2. The abscissa X4 on the axis LL of the apex of the notches is therefore at least equal to the abscissa X2 at the start of the end part 1a.

With reference to FIG. 5, according to a first embodiment, the radius of the cross section of the inner wall 2 of the nozzle is circular as far as an abscissa X5 which corresponds to a neck at which the area of the cross section of the duct passes through a minimum. The line 16 defining the inner wall 2 of the nozzle 1 downstream of the abscissa X5 of the neck in the axial plane passing through the apex 15A of a notch 15 deviates radially, towards the outside, from the tangent T1 passing through the point of the inner wall at the abscissa X5 at the neck and carries the internal flow towards the outside. Moreover, the line 17 defining the inner wall 2 of the nozzle 1 downstream of the abscissa X5 of the neck in the axial plane passing through the point 7A of a chevron 7 deviates radially, towards the inside, from the tangent T2 passing through the point of the inner wall at the abscissa X5 at the neck and penetrates the chevron 7 in the internal flow. The surface of the inner wall 2 between the point 7A of a chevron 7 and the apex 15A of a notch 15 is formed by means known to a person skilled in the art for regularly connecting the lines 16 and 17 that are thus defined in the two corresponding axial planes by resting upstream on the arc of circle 18 of the inner wall 2 in the transverse plane at the abscissa X5 at the neck and downstream on the trailing edge 14 of the nozzle 1.

According to this embodiment, the chevrons 7 and the notches 15 are consecutive in a periodic manner. Periodic modulations in the radius of the inner wall 2 of the nozzle are thus obtained in the end region 1a, from the abscissa X5 of the neck. These modulations correspond to a distribution in azimuth of hollow sectors in the inner wall 2, which are centred on the notches 15, and sectors returning to the flow, which are centred on the chevrons 7.

Moreover, the nozzle 1 may have a significant thickness in the end part 1a. The modifications to the outer wall 3 in this end part 1a may start from a defined abscissa that is different from the abscissa X5 of the neck. With reference to FIG. 5, in the example shown, this abscissa is lower than that of the neck and corresponds to the abscissa X2 at the start of the end part 1a. The line 19 defining the outer wall 3 of the nozzle downstream of this abscissa X2 in an axial plane passing through the apex 15A of a notch 15 and the line 20 in an axial plane passing through the point 7A of a chevron 7 come closer to the tangent T1 and the tangent T2, respectively, passing through the point of the abscissa X5 at the neck in the corresponding axial plane. Since the surface of the outer wall 3 of the nozzle is defined in the end part 1a by means similar to those used for the inner wall 2, a convergence of the internal and external flows is thus produced with a view to accelerating the mixing.

The penetration of the chevrons 7 is a parameter that is important for the efficiency of noise reduction by means of these chevrons. However, this penetration has a negative effect on the operational performance of the nozzle 1 by reducing the effective outlet section, in particular for speeds having low expansion ratios. The variations in radius of the inner wall 2 between the notches 15 and the chevrons 7 that are introduced downstream of the abscissa X5 of the neck in this first embodiment make it possible to compensate for this effect and to increase the effective outlet section.

Furthermore, for such an embodiment, a modulation effect in azimuth on the Mach number of the flow in the duct in the vicinity of the inner wall 2 is observed, in the region of the chevrons and the neck, in the end part 1a of the nozzle. FIG. 6 shows the Mach-number distribution in a flow simulation that is representative of the operating mode corresponding to the noise results from FIG. 4. Iso-Mach lines are shown here in the transverse plane of the abscissa X5 at the neck in an angular sector between the apex 15A of a notch 15 and the point 7A of a chevron 7. In this figure, it is shown a projection of the trailing-edge line 14 in the transverse plane to indicate the position relative to the notch 15 and to the chevron 5. The line C1 has an iso-Mach value of 1, the line C2 has an iso-Mach value of 0.9, and the lines C3 and C4 have decreasing iso-Mach values. From these results, it is noted that, in the vicinity of the neck, in an annular region in which the supersonic flow begins to appear, pockets are formed that are regularly distributed in azimuth in which the flow remains subsonic.

On this point, it should be noted that other types of solutions involving chevrons 7 which do not correspond to the invention and for which the inner wall 2 of the nozzle 1 has been shaped to improve the operability problems but maintain a cross section resting on circles downstream of the neck do not produce this effect. The same simulations using this type of solution produce a circular ring of greater than Mach 1 under the same conditions. It can also be seen in FIG. 6 that the minimum Mach number in azimuth in the region of the neck is produced for an intermediate azimuth between the plane of the point 7A of the chevron 7 and the plane of the apex 15A of the notch 15. The effect observed is therefore indeed due to the combination of the presence of the chevrons 7 and the modulations in azimuth of the radius of the inner wall 2 of the nozzle 1 in this end part 1a.

The invention is not limited to this first embodiment in the end part 1a. In particular, in a first variant, the modulations in azimuth of the radius of the inner wall 2 of the nozzle 1 may begin upstream of the abscissa X5 of the neck.

Moreover, in another embodiment, the nozzle 1 may not have a significant thickness in the end region 1a. In this case, the changes in the outer wall 3 in this end part 1a follow those of the inner wall 2.

In addition, as has been indicated above, the shape of the chevrons 7 may be more complex than that shown in FIG. 5. Likewise, the variations in azimuth of the radius of the inner wall 2 may follow more complex laws than regular changes between values determined in the radial planes at the two ends of a sector defined by the apex 15A of a notch 15 and the point 7A of an adjacent chevron 7.

The invention lastly relates to the combination of a lobed mixer 6 and a ring of chevrons 7 on the inner wall 2 that is undulating in the circumferential direction, these elements corresponding to the embodiments that have been previously introduced.

In a preferred embodiment, with reference to FIG. 7, the lobed mixer 6 and the ring of chevrons 7 have a periodic geometry in azimuth, having an identical number of chevrons 7 and hot lobes 12. The ring of chevrons 7, produced according to the embodiment corresponding to FIG. 5, is provided with a pitch in azimuth such that the point 7A of the chevrons 7 is positioned in the same axial plane as the high point 11 of the hot lobes 12. This high point 11 corresponds, for the embodiment provided in the example, to the centre of the hot lobe 12 in the azimuth direction.

It is possible to obtain, by means of calculations or test measurements, an estimate of the spatial distribution of the vortex intensity of the flow in the nozzle for an operating mode of the nozzle. This embodiment corresponds to the fact that the zone of maximum vortex intensity produced at the interfaces between the successive hot lobes 12 and cold lobes 13 of the mixer passes, in the region close to the inner wall 2 at the end part 1a of the nozzle, into pockets in which the Mach number of the flow is close to a minimum in azimuth. The interaction between these vortices and the part of the flow in which the Mach number is greater than 1 is therefore minimised.

FIG. 8 shows the positive effect of the interaction between the lobed mixer 6 and the ring of chevrons 7 on the inner wall 2 that are undulating in the circumferential direction. It shows the acoustic gain, expressed in decibels relative to the logarithm of the frequency, obtained by the chevrons 7 on the distant noise generated by the jet, at 90 degrees relative to the axis of the turbojet engine on the side of the jet engine. These results are obtained for the same operating mode of the turbojet engine and the same nozzle, in front of the end part 1a, as those shown in FIG. 4. The curve L3 shows the gain obtained with the ring of chevrons 7 corresponding to the embodiment described in FIG. 5 compared with the smooth nozzle, when there is no lobed mixer. The curve L4 shows the gain obtained by means of the invention combining the ring of chevrons 7 and the lobed mixer 6 in the embodiment corresponding to FIG. 7, compared with the smooth nozzle together the same lobed mixer 6.

The results shown in FIGS. 4 and 8 were obtained by producing reduced-scale models of the embodiments of the invention or of the configurations used for the comparisons, then by taking measurements in a test means. Using methods for calculating the flows and then the distant noise generated may constitute an alternative to this estimation method.

The curve L3 shows the operation of the ring of chevrons 7 without the lobed mixer. It is noted that the presence of the chevrons 7 leads to significant acoustic gains, of approximately 1.5 dB, for low frequencies of less than 1000 Hz. Said curve also shows a maximum high-frequency penalty of around 1.8 dB at a frequency of around 4000 Hz.

It is noted from the curve L4 that the interaction between the chevrons 7 on the undulating inner wall in the circumferential direction amplifies the action of the lobed mixer 6 at low frequency since the maximum gain obtained is approximately 2 dB for frequencies close to 250 Hz, and this is a gain over that already obtained in this region of the spectrum using the lobed mixer 6, and this can also be seen on the curve L2 in FIG. 4.

It is also noted that the degradation in acoustic performance at high frequencies is generally lower and that the maximum penalty is put back towards higher frequencies of around 8000 Hz instead of 4000 Hz. This last point is also of interest since the noise intensity is lower at these frequencies and therefore less of a nuisance.

Other embodiments are conceivable. In a first variant, with reference to FIG. 9, the point 7A of the chevrons 7 may be positioned opposite the low points 10 of the cold lobes 13. Depending on the results shown in FIG. 6 for the Mach-number distribution, this configuration should also be made consistent with the minimum Mach numbers in the region close to the chevrons having zones of maximum vortex intensity. However, results are observed that are of slightly less interest. The maximum low-frequency gain is approximately 1.5 dB and the maximum penalty is positioned at lower frequencies.

In other embodiments, the distribution of the chevrons 7 is always periodic, but with a different number to that for the hot lobes 12 of the mixer 6. In a first variant, with reference to FIG. 10, the number of chevrons 7 is equal to half the number of hot lobes 12, the point 7A of each chevron 7 being positioned in azimuth opposite the centre of a hot lobe 12.

In a second embodiment, with reference to FIG. 11, the number of chevrons 7 is double the number of hot lobes 12 of the mixer 6, the centre of each hot lobe 12 being positioned in azimuth opposite the point 7A of a chevron 7.

The results for the acoustic gains using these variants are also of slightly less interest than those for the preferred embodiment. Moreover, it is noted that these configurations do not systematically make all the zones of maximum vortex intensity having zones of minimum Mach number consistent in azimuth in the region close to the chevrons.

The variants described may, however, be of interest if structural or operation constraints require there to be different numbers of chevrons 7 and hot lobes 12. More generally, the strict periodicity of the lobes and/or the chevrons may not be possible in a given application. In addition, complex three-dimensional effects may modify the azimuth distribution of the vortex zones in certain design variants.

The invention therefore also relates to afterbodies for mixed-flow jet engines, comprising a lobed mixer 6 and a nozzle 1 equipped with an end part 1a having a ring of chevrons 7 on the inner wall 2 that undulates in the circumferential direction, which chevrons are obtained by a design method that determines the azimuth pitch of the ring of chevrons 7 relative to the hot lobes 12 of the lobed mixer 6. An example of such a method may comprise the steps that are briefly described below.

In a first step, a smooth afterbody nozzle 1 that is suitable for fulfilling operational criteria of the mixed-flow jet engine is provided. These criteria include at least one performance condition at cruising speed and one operability condition between several operating modes.

In a second step, a ring of chevrons 7 on the inner wall 2 that undulates in the circumferential direction is defined on the end part 1a of the nozzle and is designed to:
obtain an acoustic gain independently of the presence of a mixer;
maintain the results obtained for the operational criteria using the smooth nozzle;
produce a zone of minimum Mach number in the vicinity of the inner wall 2 of the nozzle 1 in each interval in azimuth between the apex 15A of a notch 15 and the point 7A of a chevron 7.

In a third step, a lobed mixer 6 is provided which improves at least the acoustic performance of the afterbody for at least one operating mode.

The second and the third step may be carried out concurrently. However, the ring of chevrons 7 is preferably designed to have a number of chevrons 7 that is equal to the number of hot lobes 12 in the mixer 6.

In a fourth step, a first azimuth pitch value is selected between the lobes of the mixer 6 and the points 7A of the chevrons 7.

In a fifth step, by way of simulation the distant noise obtained using this configuration is analysed for at least one direction and for at least one operating mode of the jet engine. Such a simulation may be carried out by means of measurements based on a model tested in a test means, as is the case for the results shown in FIGS. 4 and 8.

In a sixth step, these analyses of distant noise are compared with an objective or with previous results. If these results are unsatisfactory, another pitch value is selected between the lobed mixer and the ring of chevrons by means of an optimisation algorithm. This algorithm may be a simple trial-and-error method or, more efficiently, an incrementation of the parameters by means of successive interpolations between values that have been estimated. The fifth step is then carried out again using this new azimuth pitch value.

The method stops when the sixth step has determined an azimuth pitch value between the lobed mixer 6 and the ring of chevrons 7 on the inner wall 2 that undulates in the circumferential direction corresponding to a maximum acoustic gain.

1. Afterbody of a mixed-flow turbojet engine, having a central axis, comprising a lobed mixer that has hot lobes returning to the secondary flow alternating with cold lobes penetrating the primary flow, and a nozzle comprising, on its trailing edge, longitudinal notches defining a ring of anti-noise chevrons, characterised in that, on a defined abscissa on the central axis downstream of the lobed mixer, the inner wall of the nozzle has a neck where the area of the passage cross section of a flow in the nozzle passes through a minimum, and in that, downstream of this defined abscissa, the radius of the inner wall of the nozzle varies between the notches and the chevrons so as to produce azimuth fluctuations in the Mach number in the flow in the vicinity of said ring of chevrons.

2. Afterbody of a mixed-flow turbojet engine according to claim 1, wherein the lobed mixer produces, in the flow in the vicinity of the ring of chevrons, spatial fluctuations in azimuth in the vortex intensity level, and wherein the ring of chevrons is positioned in azimuth relative to the lobed mixer such that, in its vicinity, the azimuth of at least one maximum vortex intensity level corresponds to a minimum Mach number in the azimuth fluctuations of the flow in the nozzle in the vicinity of the ring of chevrons.

3. Afterbody of a turbojet engine according to claim 1, wherein the lobed mixer and the nozzle together with the ring of chevrons are each rotationally symmetrical about the axis of the turbojet engine.

4. Afterbody of a turbojet engine according to claim 3, wherein the number of hot lobes of the mixer and the number of chevrons are identical.

5. Afterbody of a turbojet engine according to claim 4, wherein the points of the chevrons are in the same axial planes as the maximum-radius points of a hot lobe.

6. Afterbody of a mixed-flow turbojet engine according to claim 1, wherein the variations in radius of the inner wall of the nozzle in the end part define, in azimuth, sectors in which the radius has a maximum value in the region of the notches and sectors in which the radius has a minimum value in the region of the chevrons.

7. Afterbody of a turbojet engine according to claim 6, wherein the surface of the inner wall of the nozzle continuously comes closer to the axis of the turbojet engine in the sectors in which the radius has a minimum value.

8. Afterbody of a turbojet engine according to claim 6, wherein the inner wall of the nozzle has a circular cross section as far as a defined abscissa, said inner wall having a defined tangent at this abscissa in the entire axial half-plane, and:
in the axial half-plane passing through the apex of a notch, the inner wall of the nozzle deviates radially, towards the outside, from said upstream tangent passing through the point of the inner wall corresponding to said abscissa in this half-plane;
in the axial half-plane passing through the point of a chevron, the inner wall of the nozzle deviates radially, towards the inside, from said upstream tangent passing through the point of the inner wall corresponding to said abscissa in this half-plane.

9. Method for designing a mixed-flow turbojet engine comprising an afterbody according to claim 1, which is designed to comprise a nozzle equipped with a ring of chevrons having variations in the radii of the inner wall between the notches and the chevrons so as to produce azimuth fluctuations in the Mach number in the flow in the vicinity of said ring of chevrons, and comprises a lobed mixer, characterised in that it comprises:
at least one step of using a method for analysing the radiated noise for at least one relative positioning value in azimuth of the mixer and of the ring of chevrons, of which the shapes have been previously defined, for at least one operating mode of the turbojet engine;
the use of an algorithm using the preceding step to determine the relative positioning in azimuth between the lobed mixer and the ring of chevrons which minimises the radiated noise analysed for said operating mode.

10. Design method according to claim 9, wherein the number of hot lobes of the mixer and the number of chevrons are equal.

11. Design method according to claim 9, wherein the afterbody is designed such that the nozzle begins to start up in an operating mode of the turbojet engine that corresponds to the flight conditions of take-off of an aeroplane that is intended to receive the turbojet engine, and wherein the relative positioning in azimuth between the lobed mixer and the ring of chevrons is determined such that the azimuth fluctuations in the Mach number produce, in the vicinity of the neck of the nozzle in an annular region in which the supersonic flow begins to appear, pockets in which the flow remains subsonic.

12. Design method according to claim 11, wherein the pockets in which the flow remains subsonic are regularly distributed in azimuth.

13. Design method according to claim 11, wherein the afterbody is designed such that the nozzle begins to start up at an expansion ratio at start-up of less than 1:7 and preferably of between 1:5 and 1:6.
